(19) United States
(12) Patent Application Publication
(10) Pub. No.: US 2016/0117093 A1
(43) Pub. Date: Apr. 28, 2016

(54) ELECTRONIC DEVICE AND METHOD FOR PROCESSING STRUCTURED DOCUMENT

(71) Applicant: Kabushiki Kaisha Toshiba, Tokyo (JP)

(72) Inventors: Sachie Yokoyama, Ome Tokyo (JP); Koji Yamamoto, Ome Tokyo (JP)

(21) Appl. No.: 14/674,207

(22) Filed: Mar. 31, 2015

(30) Foreign Application Priority Data
Oct. 24, 2014 (JP) 2014-216940

(51) Int. Cl. G06F 3/0488; G06F 17/22; G06F 3/0484

(52) U.S. Cl. CPC G06F 3/04883; G06F 3/04845; G06F 17/2247; G06F 17/2205

(57) ABSTRACT

According to one embodiment, an electronic device displays content of a first document described in a markup language on a screen. The first document includes a plurality of elements. The electronic device performs a process of storing a part of the first document as clipping data based on a first clipping range on the screen, the first clipping range specified by a first handwritten stroke. The part of the first document includes one or more first elements of the plurality of elements. The one or more first elements are determined by comparing the first clipping range with display positions on the screen on which contents of elements are displayed respectively. The display positions are obtained from a screen image of the first document.

### CROSS-REFERENCE TO RELATED APPLICATIONS

This application is based upon and claims the benefit of priority from Japanese Patent Application No. 2014-216940, filed Oct. 24, 2014, the entire contents of which are incorporated herein by reference.

### FIELD

Embodiments described herein relate generally to a technique for processing a structured document.

### BACKGROUND

In recent years, various types of electronic devices such as tablets, PDAs and smartphones have been developed. These devices have become widespread as tools for viewing structured documents such as HTML documents. A typical example of a structured document is a Web page.

Recently, a clipping function has attracted attention. For example, the user can use the clipping function to save an interesting article of a Web page in a database.

However, the conventional technique does not consider that a part of a structured document is clipped by a user's intuitive operation.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an external appearance of an electronic device according to an embodiment.

FIG. 2 shows an example of a document which is handwritten on a touchscreen display of the electronic device of FIG. 1.

FIG. 3 is an exemplary diagram shown for explaining time-series data corresponding to the handwritten document of FIG. 2.

FIG. 4 is an exemplary block diagram showing a configuration of the electronic device of FIG. 1.

FIG. 5 is an exemplary diagram shown for explaining a clipping process executed by the electronic device of FIG. 1.

FIG. 6 is an exemplary block diagram showing a functional configuration of a browser application program executed by the electronic device of FIG. 1.

FIG. 7 is an exemplary diagram shown for explaining the content of an HTML document displayed on a screen and a selection range (clipping range) specified by handwriting.

FIG. 8 is shown for explaining an example of a layout analysis process based on an image process.

FIG. 9 shows an example of clipping data.

FIG. 10 is an exemplary diagram shown for explaining an operation for storing image data corresponding to a selection range (clipping range) together with text in an HTML document.

FIG. 11 is shown for explaining an example of the relationship between an HTML document (HTML source) and the display content of a browser window.

FIG. 12 is an exemplary diagram shown for explaining DOM objects corresponding to the HTML source of FIG. 11.

FIG. 13 is an exemplary diagram shown for explaining a process for generating clipping data (an HTML file).

FIG. 14 is an exemplary flowchart showing a procedure of an HTML document display process executed by the electronic device of FIG. 1.

FIG. 15 shows an example of a first element list generated by the electronic device of FIG. 1.

FIG. 16 is an exemplary flowchart showing a procedure of a range selection process executed by the electronic device of FIG. 1.

FIG. 17 shows an example of a second element list generated by the electronic device of FIG. 1.

FIG. 18 is an exemplary flowchart showing procedure of a clipping data output process executed by the electronic device of FIG. 1.

### DETAILED DESCRIPTION

Various embodiments will be described hereinafter with reference to the accompanying drawings.

In general, according to one embodiment, an electronic device comprises a display controller and circuitry. The display controller is configured to display content of a first document described in a markup language on a screen. The first document comprises a plurality of elements. The circuitry is configured to perform a process of storing a part of the first document as clipping data based on a first clipping range on the screen, the first clipping range specified by a first handwritten stroke, the part of the first document comprising one or more first elements of the plurality of elements. The one or more first elements are determined by comparing the first clipping range with display positions on the screen on which contents of elements are displayed respectively. The display positions are obtained from a screen image of the first document displayed on the screen

FIG. 1 is a perspective view showing an external appearance of an electronic device according to an embodiment. The electronic device is, for example, a stylus-based mobile electronic device which enables handwriting input by a stylus or a finger. The electronic device can be realized as, for example, a tablet computer, a notebook computer, a smartphone or a PDA. Hereinafter, this specification assumes that the electronic device is realized as a tablet computer 10. The tablet computer 10 is a mobile electronic device which can be called a tablet or a slate computer. The tablet computer 10 can function as a device for utilizing, for example, Web browsing, e-mail and social network services (SNSs). As shown in FIG. 1, the tablet computer 10 comprises a main body 11 and a touchscreen display 17. The main body 11 comprises a housing which has a thin-box shape. The touchscreen display 17 is attached such that it overlaps the upper surface of the main body 11.

A flat-panel display and a sensor are incorporated into the touchscreen display 17. The sensor detects the contact position between a stylus or a finger and the screen of the flat-panel display. The flat-panel display may be, for example, a liquid crystal display (LCD). As the sensor, for example, a capacitive touchpanel or an electromagnetic induction digitizer can be used. Hereinafter, this specification assumes that both of the two types of sensors, which are a digitizer and a touchpanel, are incorporated into the touchscreen display 17. However, the present embodiment is not limited to this structure.

For example, the digitizer is provided under the screen of the flat-panel display. For example, the touchpanel is provided on the screen of the flat-panel display. The touchscreen display 17 is configured to detect a touch operation which is conducted on the screen by using a stylus 100 as well as a touch operation which is conducted on the screen by using a finger. For example, the stylus 100 may be a digitizer stylus (electromagnetic induction stylus), an active stylus or a passive stylus.

The user can conduct a handwriting input operation on the touchscreen display 17 by using an external object (the stylus 100 or a finger). In the present embodiment, some application programs installed in the tablet computer 10 support a handwriting input function. For example, a Web browser application program (Web browser) installed in the tablet computer 10 can draw handwritten strokes by the stylus 100 on the Web page which is currently displayed.

During the handwriting input operation, the locus of the move of the stylus 100 on the screen is drawn in real time. In other words, a stroke (handwritten stroke) is drawn in real time. The locus of the move of the stylus 100 while the stylus 100 comes into contact with the screen is equivalent to one stroke.

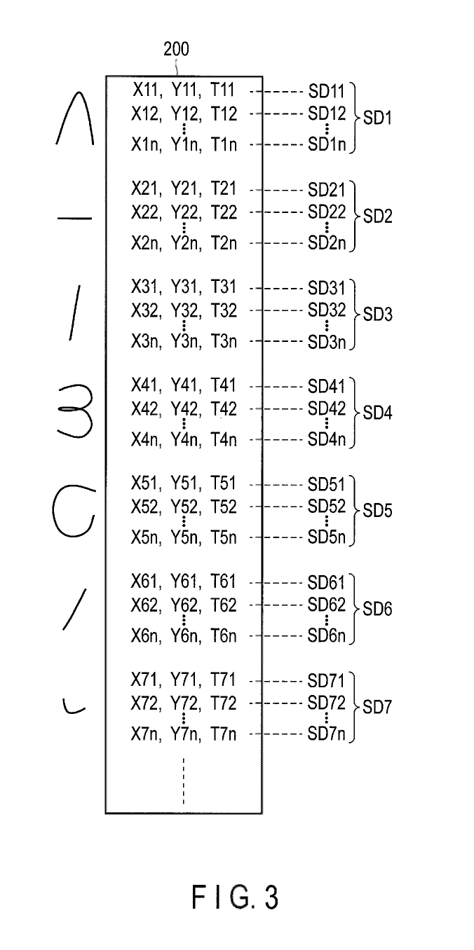

In the present embodiment, handwritten strokes are not stored as image data. Instead, handwritten strokes are stored in a storage medium as time-series data indicating the coordinate series of locus of each stroke and the order relationship of the strokes. The detail of the time-series data is explained later with reference to FIG. 3. Briefly speaking, the time-series data includes a plurality of stroke data items corresponding to a plurality of strokes respectively. Each stroke data item corresponds to a stroke, and includes a series of coordinate data items (time-series coordinates) corresponding to points on the stroke respectively. The order of the stroke data items is equivalent to the order in which the strokes are handwritten, or in short, the writing order.

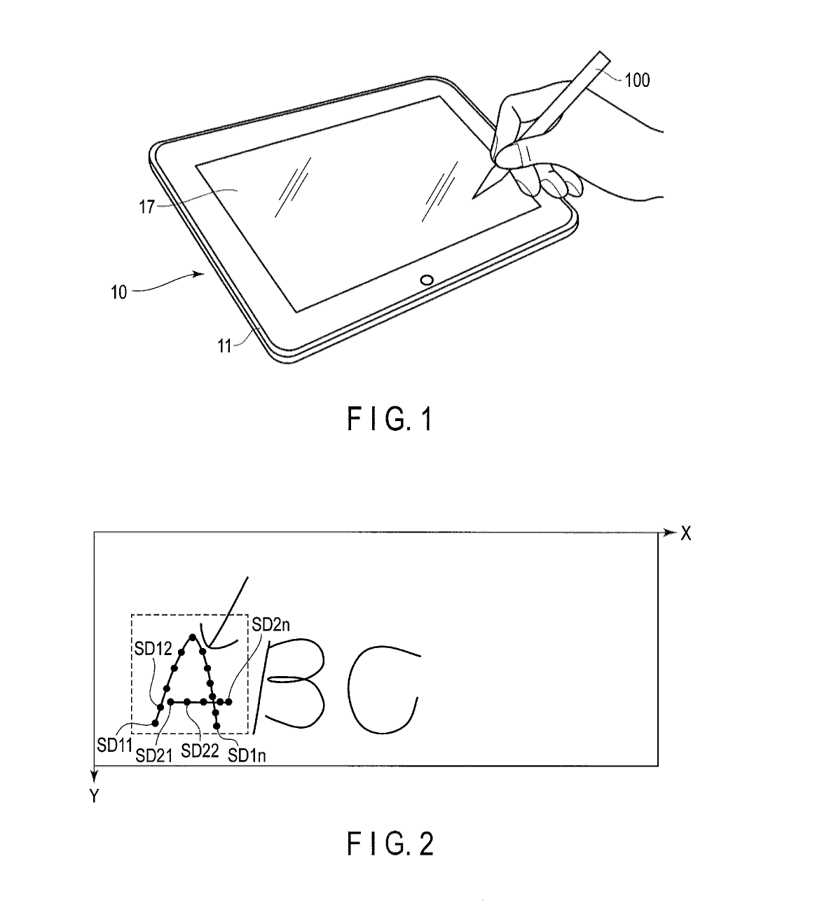

Now, this specification explains the relationship between strokes which are made by the user and time-series data with reference to FIG. 2 and FIG. 3.

FIG. 2 shows an example of a character string which is handwritten on the touchscreen display 17 by using the stylus 100, etc.

In the tablet computer 10, strokes can be drawn on a Web page, a presentation document, an image and other various electronic documents by the stylus 100. For example, the user can freely handwrite annotation on a Web page.

FIG. 2 assumes the following case: a character string “ABC” is handwritten in the order of “A”, “B” and “C”, and subsequently, an arrow is handwritten in vicinity to the handwritten character “A”.

The handwritten character “A” is shown by two strokes (the stroke having a “̂”-shape and the stroke having a “-”-shape) which are handwritten by using the stylus 100, etc. For example, the first stroke having a “̂”-shape is sampled in real time at equal time intervals. This enables acquisition of time-series coordinates SD11, SD12, . . . , SD1n of the stroke having a “̂”-shape. In a similar manner, the next stroke having a “-”-shape is sampled in real time at equal time intervals. This enables acquisition of time-series coordinates SD21, SD22, . . . , SD2n of the stroke having a “-”-shape.

The handwritten character “B” is shown by two strokes which are handwritten by using the stylus 100, etc. The handwritten character “C” is shown by one stroke which is handwritten by using the stylus 100, etc. The handwritten arrow is shown by two strokes which are handwritten by using the stylus 100, etc.

FIG. 3 shows time-series data 200 corresponding to the handwritten character string of FIG. 2. The time-series data 200 includes a plurality of stroke data items SD1, SD2, . . . , SD7. In the time-series data 200, stroke data items SD1, SD2, . . . , SD7 are arranged in the writing order, or in other words, in the order in which the strokes are handwritten.

In the time-series data 200, the first two stroke data items (SD1 and SD2) show the two strokes of the handwritten character “A” respectively. The third and fourth stroke data items (SD3 and SD4) show the two strokes constituting the handwritten character “B” respectively. The fifth stroke data item (SD5) shows the stroke constituting the handwritten character “C”. The sixth and seventh stroke data items (SD6 and SD7) show the two strokes constituting the handwritten arrow respectively.

Each stroke data item includes a plurality of coordinates corresponding to a plurality of points on a stroke, respectively. In each stroke data item, the coordinates are arranged in chronological order in which the stroke is handwritten. For example, with respect to the handwritten character “A”, stroke data item SD1 includes a series of coordinate data items (time-series coordinates) each corresponding to a point on the stroke having a “̂”-shape. In other words, stroke data item SD1 includes n coordinate data items SD11, SD12, . . . , SD1n. Stroke data item SD2 includes a series of coordinate data items each corresponding to a point on the stroke having a “-”-shape. In other words, stroke data item SD2 includes n coordinate data items SD21, SD22, . . . , SD2n. The number of coordinate data items may differ depending on the stroke data item.

Each coordinate data item indicates the X-coordinate and the Y-coordinate which correspond to a point on the corresponding stroke. For examples, coordinate data item SD11 indicates the X-coordinate (X11) and the Y-coordinate (Y11) of the starting point of the stroke having a “̂”-shape. SD1n indicates the X-coordinate (X1n) and the Y-coordinate (Y1n) of the end point of the stroke having a “̂”-shape.

Each coordinate data item may further include timestamp data T corresponding to the time point in which the point corresponding to the coordinate is handwritten. The time point in which the point is handwritten may be an absolute time (for example, year, month, day, hour, minute, second), or may be a relative time based on a certain time point. For example, the absolute time (for example, year, month, day, hour, minute, second) at which a stroke began to be handwritten may be added as timestamp data to each stroke data item. Further, a relative time indicating the difference from the absolute time may be added as timestamp data T to each coordinate data item in the stroke data item.

Moreover, data Z indicating the writing pressure may be added to each coordinate data item.

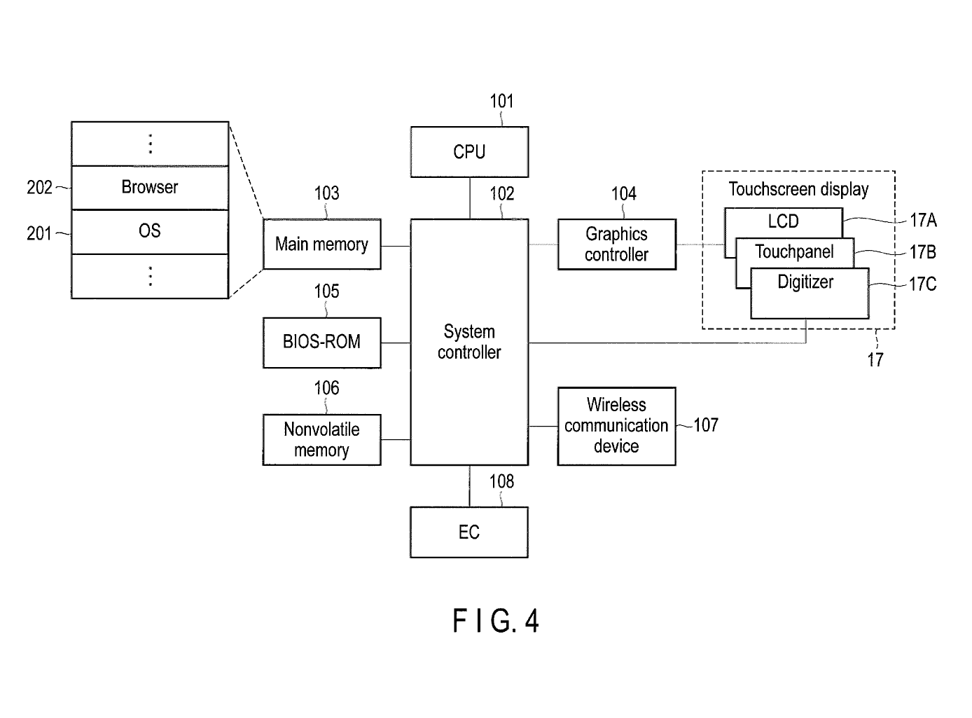

FIG. 4 shows a configuration of the tablet computer 10.

The tablet computer 10 comprises, as shown in FIG. 4, a CPU 101, a system controller 102, a main memory 103, a graphics controller 104, a BIOS-ROM 105, a nonvolatile memory 106, a wireless communication device 107, an embedded controller (EC) 108 and the like.

The CPU 101 is a processor configured to control operations of various components in the tablet computer 10. The processor includes circuitry (processing circuitry). The CPU 101 executes various computer programs which are loaded into the main memory 103 from the nonvolatile memory 106 which is a storage device. The programs include an operating system (OS) 201 and various application programs. The application programs include a browser application program (Web browser) 202.

The browser application program 202 is configured to display the content of a structured document described in a markup language on the browser window of the browser application program 202. For example, the structured document may be an HTML document or an XML document. Web pages are mostly HTML documents. Hereinafter, this specification assumes that the structured document is an HTML document.

The browser application program 202 has a function for obtaining an HTML document from a Web server, a function for displaying the content of an HTML document on the screen (browser window), and a function for performing a clipping process. The browser window includes an address bar, a status bar and a content display area (viewport). The content display area is an area in which the content of an HTML document can be displayed, or in other words, an area in which a Web page can be displayed.

The clipping process is a function for storing a part of the HTML document (Web page) which is currently displayed as clipping data (Web clipping) in a storage medium.

The browser application program 202 comprises a handwriting engine which enables the user to draw strokes with the stylus 100. The handwriting engine enables the user to draw strokes (handwritten strokes) on a Web page with the stylus 100.

The CPU 101 executes a Basic Input/Output System (BIOS) stored in the BIOS-ROM 105. The BIOS is a program for hardware control.

The system controller 102 is a device configured to connect a local bus of the CPU 101 and various components. The system controller 102 comprises a built-in memory controller configured to control the access to the main memory 103. The system controller 102 also has a function for communicating with the graphics controller 104 via a serial bus conforming to the PCI EXPRESS standard.

The graphics controller 104 is a display controller configured to control an LCD 17A used as a display monitor of the tablet computer 10. The graphics controller 104 includes display control circuitry. When the browser application program 202 is executed, the graphics controller 104 displays an HTML document, an image and a stroke on the screen, under the control of the browser application program 202. A display signal generated by the graphics controller 104 is transmitted to the LCD 17A. The LCD 17A displays a screen image based on the display signal. On the LCD 17A, a touchpanel 17B is provided. Under the LCD 17A, a digitizer 17C is provided. The graphics controller 104 may be housed in the CPU 101.

The wireless communication device 107 is a device configured to perform wireless communication using, for example, a wireless LAN or 3G mobile communication. The wireless communication device 107 includes a transmitter configured to transmit a signal and a receiver configured to receive a signal.

The EC 108 is a single-chip microcomputer including an embedded controller for power management. The EC 108 has a function for turning the tablet computer 10 on or off in accordance with the operation of the power button by the user.

The tablet computer 10 may comprise peripheral interfaces for communicating with other input devices (for example, a mouse and a keyboard).

Now, this specification explains some features of the browser application program 202.

In a handwriting mode, the browser application program 202 draws strokes by the stylus 100. The user can turn the handwriting mode on or off. The browser application program 202 may have a touch input mode. In the touch input mode, strokes can be drawn by a touch (finger gesture) or a mouse. The touch input mode is a mode for drawing strokes by a finger or a mouse. The user can turn the touch input mode on or off.

Now, this specification explains features of the clipping function.

The browser application program 202 performs a clipping process for storing a part of the displaying HTML document (Web page) as clipping data. The clipping process is executed based on the selection range (clipping range) on the screen. The selection range on the screen is specified by a handwritten stroke.

For example, in a clipping mode, a stroke which is input by handwriting is used for selecting the range to be clipped on the Web page. A circumscribed area of the handwritten stroke, for example, the circumscribed rectangle of the stroke may be used as the selection range (clipping range). A part of the Web page is specified by the clipping range. This part is, or in other words, some elements in the HTML document are the area to be clipped.

The browser application program 202 supports a plurality of pen types. The pen types may include some drawing pens for drawing strokes and a clipping pen for specifying the clipping range. The user can select a drawing pen or the clipping pen by operating the user interface displayed on the screen or the side buttons of the stylus 100. When a drawing pen is selected, the handwriting mode may be enabled. When the clipping pen is selected, the clipping mode may be enabled.

The browser application program 202 supports a copy/cut/paste function. The copy/cut/paste function may use a clipboard function of the OS. The clipboard is a temporal storage area for exchange data between application programs. The browser application program 202 can perform the following copy.

“Copy as an image”: The browser application program 202 is configured to copy (store) a part of a Web page on which a handwritten stroke is drawn or the whole Web page as an image (image data) in a storage area such as a clipboard. The image is, for example, a bitmap. The browser application program 202 converts a part of a Web page on which a handwritten stroke is drawn or the whole Web page into image data, and copies (stores) the image data in the clipboard.

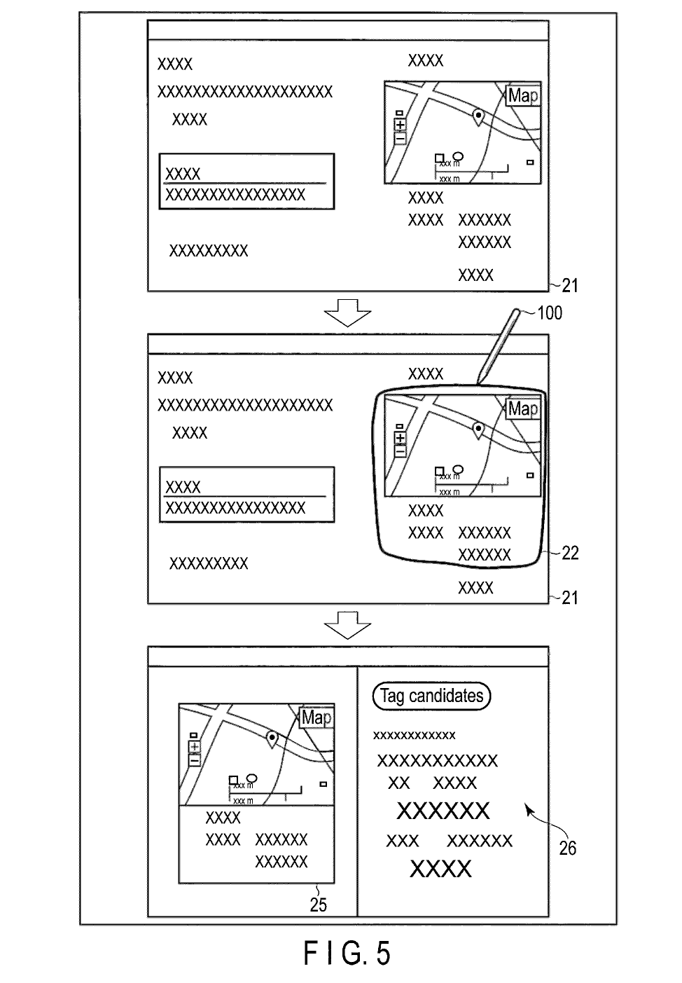

FIG. 5 is shown for explaining the clipping process.

This specification assumes that a clipping is extracted from the Web page which is displayed in progress.

On the screen, a Web page 21 containing text and images is displayed. For example, the user launches the browser application program 202 to display the content of a desired HTML document on the screen, or in other words, to display the Web page 21 on the screen.

The user may want to save an interesting part of the Web page 21 while browsing the Web page 21. In this case, for example, by using the stylus 100, the user conducts a clipping operation for specifying a part of the Web page 21 which is displayed in progress.

In this embodiment, the clipping operation can be conducted by the stylus 100.

In the clipping mode, when the user handwrites a stroke (clipping stroke) 22 having a shape surrounding an interesting part by using the stylus 100, the clipping range is determined by the clipping stroke. The clipping range may be, for example, a rectangle surrounding the clipping stroke 22 (in other words, the circumscribed rectangle of the clipping stroke 22).

The browser application program 202 extracts clipping data (a Web clipping) 25 which corresponds to a part of the Web page 21 based on the determined clipping range. For example, of a plurality of elements in the HTML document corresponding to the Web page 21, one or more elements which overlap the clipping range are extracted from the HTML document. The clipping data includes the extracted element or elements, and image data referred by the element or elements.

In the present embodiment, the clipping range can be specified by the clipping stroke 22. Therefore, the user can easily specify an interesting part of the Web page 21 by an intuitive operation.

Moreover, in the present embodiment, a layout analysis process is applied to the Web page 21 on the basis of an image process such that the elements to be extracted can be determined by using data which is as close to the layout of the Web page 21 the user is actually viewing as possible.

In the layout analysis process based on an image process, the screen image of the HTML document which is displayed on the screen is used. The screen image may be the screenshot of the HTML document which is displayed on the screen. The screenshot is a screen image (image data) representing the content of the Web page which is displayed in the content display area on the browser window.

The screenshot may be captured in response to input of a clipping stroke by the clipping pen. For example, the screenshot may be captured at either the starting time or the ending time of the input of the clipping stroke.

The browser application program 202 performs the layout analysis process of the screenshot. This process determines a plurality of display positions (a plurality of screen display positions) in which content items corresponding to a plurality of elements in the HTML document are displayed respectively.

The browser application program 202 determines an element to be extracted from the HTML document by comparing the clipping range with the display positions. In this case, for example, when a content item corresponding to an element of the HTML document overlaps the clipping range, the element may be determined as the element to be extracted. When the clipping range overlaps two content items, two elements corresponding to the two content items may be determined as the elements to be extracted.

As described above, the present embodiment performs the layout analysis of the screenshot which is very similar to the layout of the Web page 21 the user is actually viewing. An element to be extracted is determined by using the layout analysis result of the screenshot. In this manner, it is possible to accurately specify an element which is in the HTML document and corresponds to a part of the Web page 21 in line with the intention of the user.

The screenshot is a still image. Therefore, even if the content of the Web page 21 is dynamically changed by the execution of a script immediately after a clipping operation is conducted with the stylus, the screenshot is not changed. Thus, even when the user clips a part of a Web page whose display content is dynamically updated, it is possible to accurately specify an element corresponding to the part of the Web page in line with the intention of the user.

The browser application program 202 generates the clipping 25 containing an element to be extracted. For example, the clipping 25 may be generated as an HTML document. The clipping 25 and tag candidates (suggestion tags) 26 corresponding to the content of the clipping 25 may be displayed. The tag candidates 26 are candidates of the tag which should be associated with the clipping 25. The tag is additional data which is associated with the clipping for organizing, searching for and identifying the clipping. As the tag, for example, an arbitrary word may be used.

When the user has selected one of the tag candidates 26, the selected tag is automatically associated with the clipping 25. The clipping 25 and the tag associated with the clipping 25 are stored in a storage medium.

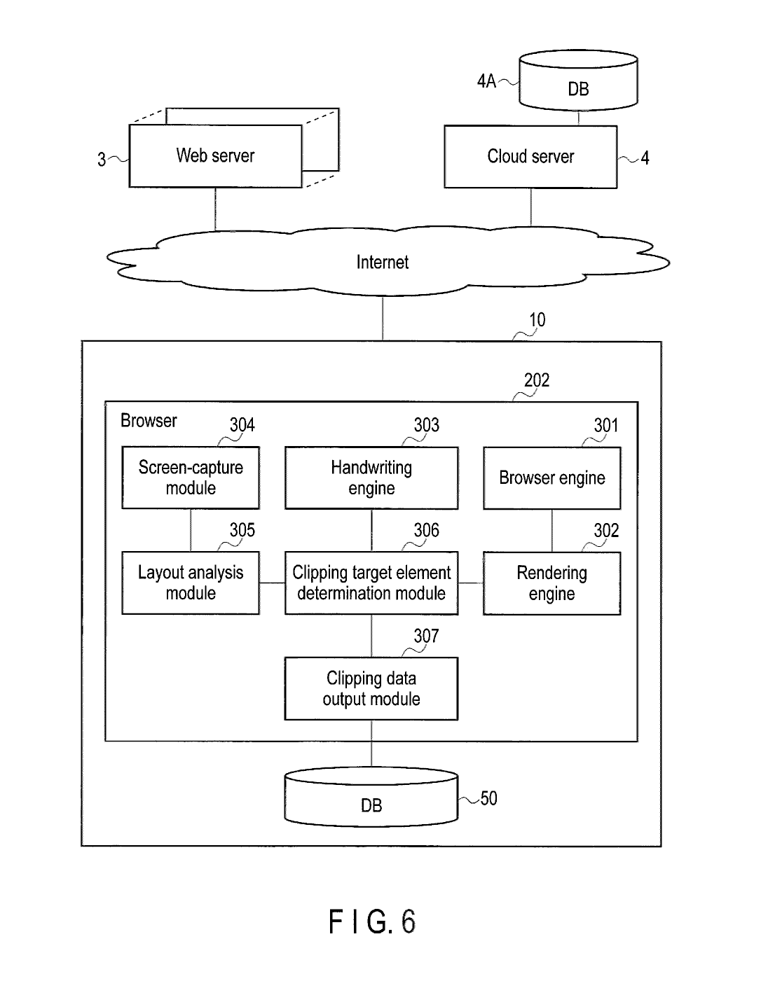

FIG. 6 shows a functional configuration of the browser application program 202.

The browser application program 202 comprises a browser engine 301, a rendering engine 302, a handwriting engine 303, a screen-capture module 304, a layout analysis module 305, a clipping target element determination module 306 and a clipping data output module 307.

The browser engine 301 obtains the HTML document (HTML file) of the URL specified by the user, and other resources associated with the HTML document such as an external file (a cascading style sheet (CSS) file and a script) and image data from a Web server 3 in cooperation with the rendering engine 302.

The rendering engine 302 performs a process for analyzing the HTML document and drawing the content of the HTML document (in short, a rendering process). In the rendering process, the rendering engine 302 starts analyzing the HTML document and converts a hierarchical structure of elements such as a DIV element and a TABLE element in the HTML document into a tree structure. The rendering engine 302 manages an object (document object model (DOM) object) corresponding to each element. The rendering engine 302 analyzes style data in the CSS file and style data in a style element. By this analysis, the rendering engine 302 obtains style data (drawing and layout data) for drawing each of elements in the HTML document. The content items corresponding to the elements are displayed on the screen based on the style data. The style data indicates the display style (the color, the size and the layout) when the content item corresponding to each element is displayed. The style data also indicates the drawing position (display position) in which the content item corresponding to each element should be displayed. In this manner, the content of the HTML document is displayed on the screen. In other words, contents corresponding to a plurality of elements in the HTML document are displayed on the screen.

The handwriting engine 303 draws handwritten strokes on a Web page by the stylus 100. In the clipping mode, a handwritten stroke which is input by the stylus 100 is used as a stroke (clipping stroke) for specifying the clipping range.

The screen-capture module 304 captures the screen image of the HTML document which is displayed on the screen as the document image of the HTML document. The screen image is the screenshot of the Web page which is displayed in progress. The screenshot may be a bitmap. The screen-capture module 304 may have a function for generating a screenshot.

The layout analysis module 305 performs a layout analysis process for detecting a structure related to the spatial arrangement of content items constituting a Web page by using the screenshot of the Web page. In the layout analysis process, the layout analysis module 305 discriminates an area (block) in which content such as text, an image and a figure is present from other grounds. The layout analysis module 305 detects the display position of each content item in the screenshot. In other words, the layout analysis module 305 detects a plurality of screen display positions in which content items corresponding to a plurality of elements in the HTML document are displayed respectively.

The clipping target element determination module 306 compares the clipping range with the plurality of display positions. In this manner, the clipping target element determination module 306 determines one or more elements to be extracted from the HTML document.

The clipping data output module 307 generates clipping data including one or more elements to be extracted, and stores the clipping data in a local database 50. The clipping data may be stored in a database 4A of a cloud server 4.

The clipping data may be an HTML document (HTML file) containing an element to be extracted. In this case, the clipping data output module 307 takes out the target element from the original HTML document, and inserts the element into the body element in a new HTML document. Further, the clipping data output module 307 extracts style data for drawing the target element from the DOM object corresponding to the target element. The extracted style data is a part of style data corresponding to the original HTML document. The clipping data output module 307 inserts the extracted style data into the body element in a new HTML document.

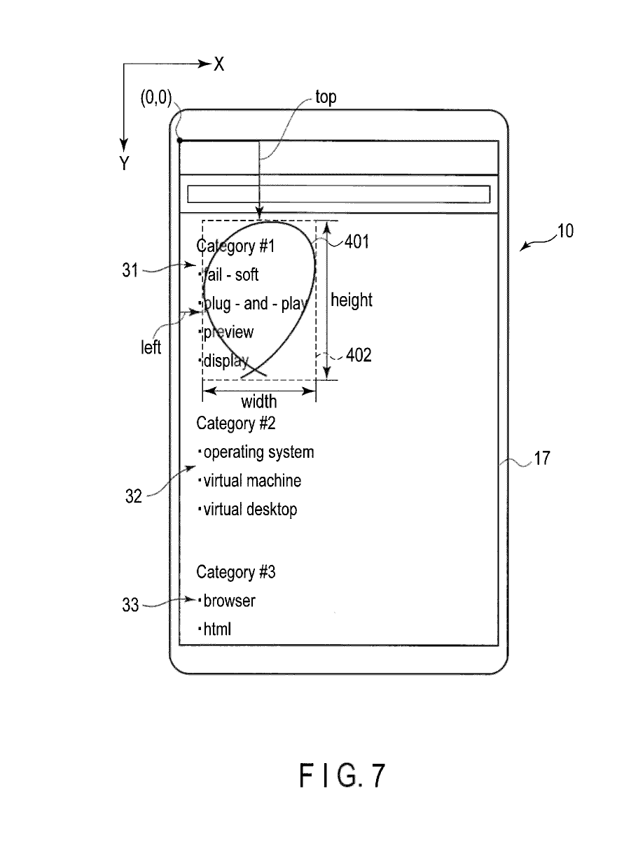

FIG. 7 shows a Web page which is displayed on the screen of the touchscreen display 17 and a clipping range which is specified by a handwritten stroke.

On the Web page, the content of the HTML document is displayed. Specifically, three content items 31 to 33 corresponding to three elements in the HTML document are displayed. Now, this specification assumes that a clipping stroke (freehand frame) 401 having a circular shape is drawn on the screen with the stylus 100. In this case, as shown in FIG. 7, the clipping target element determination module 306 determines a rectangle 402 (top, left, width, height) which circumscribes the clipping stroke 401 as the clipping range.

The top and left of the clipping range (rectangle 402) may be values relative to the original point of the physical screen (the upper left corner of the physical screen). The top of the rectangle 402 shows the distance between the upper end of the screen of the display 17 which is the physical screen and the upper end of the rectangle 402 (in short, the Y-coordinate of the upper left corner of the rectangle 402). The left of the rectangle 402 shows the distance between the left end of the screen of the display 17 and the left end of the rectangle 402 (in short, the X-coordinate of the upper left corner of the rectangle 402).

In FIG. 7, the clipping stroke 401 is shown by a solid line. However, the clipping stroke 401 may be, for example, temporarily displayed by a broken line and automatically disappear from the screen after the clipping range is determined.

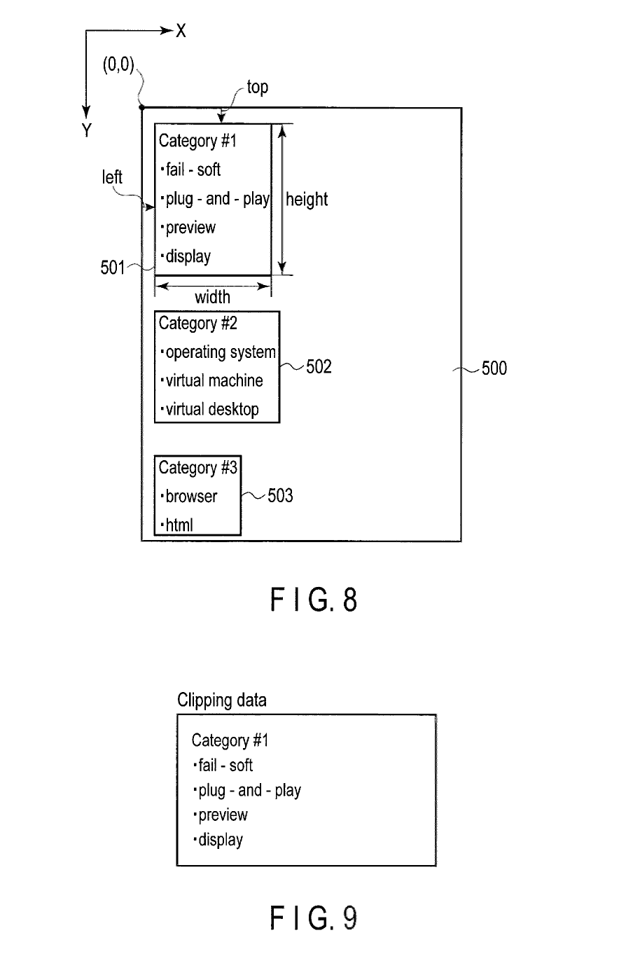

FIG. 8 shows the screenshot of the Web page of FIG. 7.

The screenshot 500 is a document image which corresponds to the content display area of the browser window.

The layout analysis module 305 applies a layout analysis process to the screenshot (document image) 500 of the Web page. In this layout analysis process, the layout analysis module 305 recognizes the layout structure related to the spatial arrangement of content items (blocks) constituting the screenshot (document image) 500, and calculates each of the display positions (top, left, width, height) of blocks 501 to 503 corresponding to content items 31 to 33 of FIG. 7.

Block 501 has a rectangular shape which circumscribes content item 31 of FIG. 7. Block 502 has a rectangular shape which circumscribes content item 32 of FIG. 7. Block 503 has a rectangular shape which circumscribes content item 33 of FIG. 7.

For example, in block 501, the top shows the distance between the upper end of the screenshot (document image) 500 and the upper end of block 501 (in short, the Y-coordinate of the upper left corner of block 501). In block 501, the left shows the distance between the left end of the screenshot (document image) 500 and the left end of block 501 (in short, the X-coordinate of the upper left corner of block 501).

The position of the clipping range (rectangle 402) of FIG. 7 is compared with each of the display positions of blocks 501 to 503 corresponding to content items 31 to 33. In this case, each of the values of the top and left of the clipping range (rectangle 402) of FIG. 7 is converted into a value corresponding to the top or left coordinate system in the document image 500. The converted position of the rectangle 402 of FIG. 7 is compared with the display position of each of blocks 501 to 503 of FIG. 8.

The clipping range (rectangle 402) of FIG. 7 overlaps block 501 corresponding to content item 31. Thus, the element corresponding to content item 31 is selected from the HTML document as the element to be extracted (the element to be clipped). As a result, as shown in FIG. 9, clipping data including the element to be extracted is generated, and is stored in a storage medium. As described above, the clipping data may be an HTML document (HTML file) including the element to be clipped or may be an XML document (XML file) including the element to be clipped.

Depending on the HTML source, content item 32 of FIG. 7 may have a text area and a wide transparent area around the text area (for example, a transparent border). In this case, the lower part of the rectangle 402 may overlap the transparent area of content item 32

However, in the above-described layout analysis process based on an image process, the values of the top, left, width and height of block 502 of FIG. 8 corresponding to content item 32 can be calculated based on a visible area including text, a figure and an image. Therefore, even if the lower part of the rectangle 402 of FIG. 7 overlaps the transparent area which is the peripheral part of content item 32, content item 32 is not selected. Thus, it is possible to select an element with high accuracy based on a content layout similar to the page layout the user is viewing without relying on the description method of the HTML source.

Instead of storing the HTML file corresponding to the clipping range, the browser application program 202 may generate image data corresponding to content item 31 which overlaps the clipping range (rectangle 402) and store the image data as clipping data.

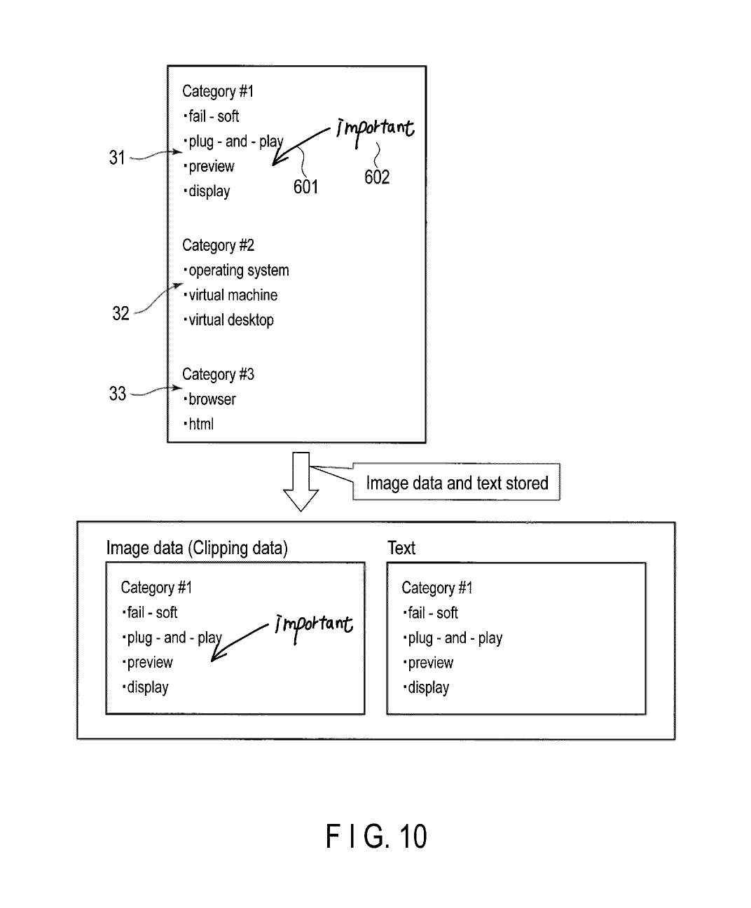

FIG. 10 shows an operation for storing image data corresponding to the clipping range as clipping data, instead of storing the HTML file corresponding to the clipping range.

FIG. 10 assumes that handwritten annotation is already drawn on the Web page. The handwritten annotation includes handwriting (strokes) 601 corresponding to a handwritten arrow, and handwriting (strokes) 602 corresponding to handwritten characters “important”. The handwriting (strokes) 601 and 602 are written on content item 31.

When an area including content item 31 is selected as the clipping range, image data corresponding to content item 31 on which handwriting 601 and 602 are written is stored as clipping data. However, in a use case where a character recognition process is applied to the clipping data afterwards, the text portion under the handwriting (strokes) may not be accurately recognized.

In the present embodiment, at the same time as the process for storing the image data corresponding to content item 31 including handwriting (strokes) 601 and 602 as clipping data, a process for storing the text in the HTML document corresponding to content item 31 in association with the clipping data is performed.

In response to a storage request for a Web page, the whole Web page which is displayed may be stored as image data. In this case, in the manner similar to the above case, at the same time as the process for storing the Web page (the display content of the HTML document) on which handwriting (strokes) 601 and 602 are written as image data, a process for storing all text items in the HTML document in association with clipping data is performed.

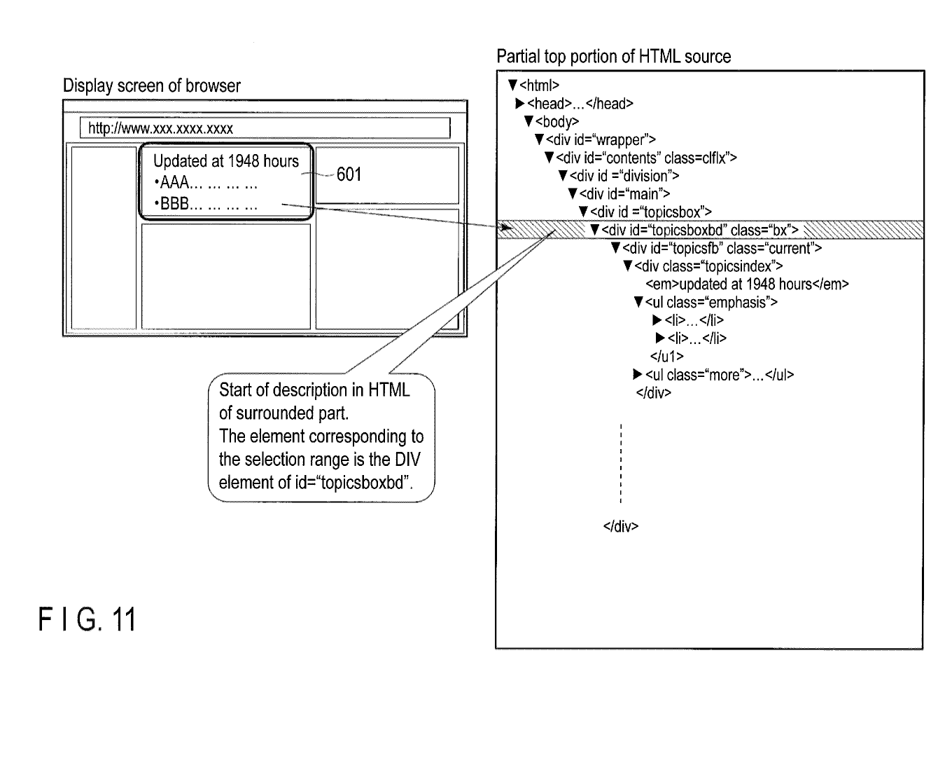

Now, this specification explains a specific example of the clipping process with reference to FIG. 11 to FIG. 13.

The right part of FIG. 11 shows a part of the top portion of an HTML document (HTML source). In HTML source, a right-pointing arrow symbol indicates an element which can be developed. A downward-pointing arrow symbol indicates an element which has been developed.

The left part of FIG. 11 shows the content of an HTML document (HTML source) which is displayed on the screen. In short, the left part of FIG. 11 shows a Web page.

This specification assumes that content item (block) 601 on the Web page is determined as a content item which belongs to the clipping range by a layout analysis process. The element corresponding to content item (block) 601 is the div element of id=“topicsboxbd” in the HTML source.

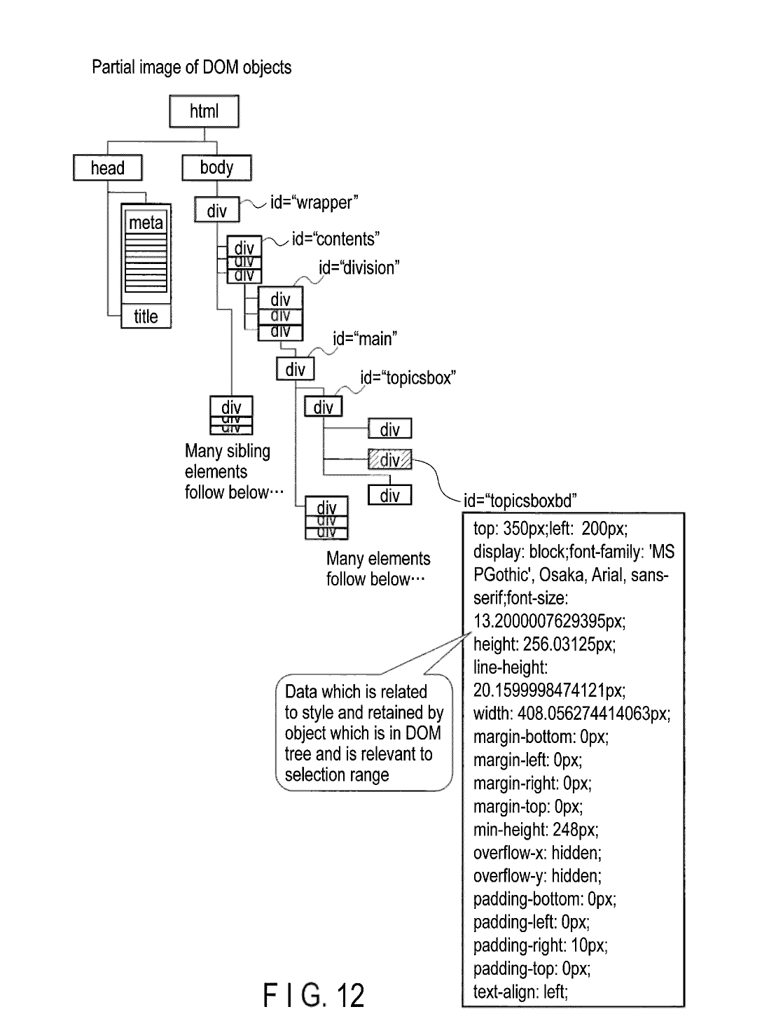

FIG. 12 shows examples of DOM objects (an example of a DOM tree) generated from the HTML source of FIG. 11 and an external CSS file, etc. Each DOM object of the DOM tree retains the above-described style data for drawing the corresponding element. The content item corresponding to each element in the HTML source is displayed in a display style (the color, the size and the layout) based on the corresponding style data.

The DOM object corresponding to the div element of id=“topicsboxbd” retains style data 602 corresponding to the div element as shown in FIG. 12. The style data 602 is the data which has been used for drawing content item 601 in FIG. 11.

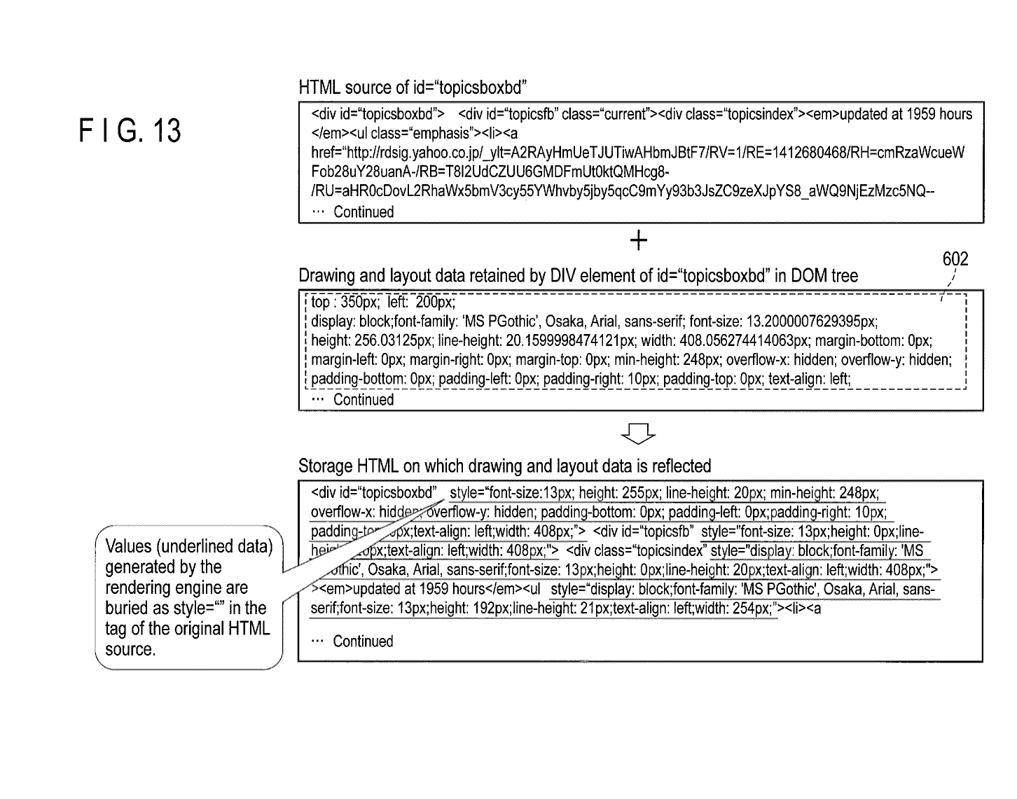

FIG. 13 shows a process for generating clipping data (an HTML file) corresponding to content item 601.

The clipping data output module 307 takes out the div element of id=“topicsboxbd” from the HTML source shown in FIG. 11. The clipping data output module 307 also takes out the style data 602 (drawing and layout data) from the DOM object corresponding to the div element of id=“topicsboxbd”.

The clipping data output module 307 buries the div element of id=“topicsboxbd” in the body of a new HTML file. Further, the clipping data output module 307 buries the style data (drawing and layout data) 602 in the div element of id=“topicsboxbd” as a style attribute (style=“ ”). In this manner, as shown by underlines in the lower part of FIG. 13, many values related to the style attribute (style=“ ”) are added to the div element.

As a result, when the browser application program 202 loads the new HTML file, it is possible to display content item 601 in the same layout as the original layout.

On the Web page corresponding to the new HTML file, content item 601 may be displayed in the top position of the content display area. Thus, the values of the top and left in the extracted style data 602 may not be buried in the div element of id=“topicsboxbd”.

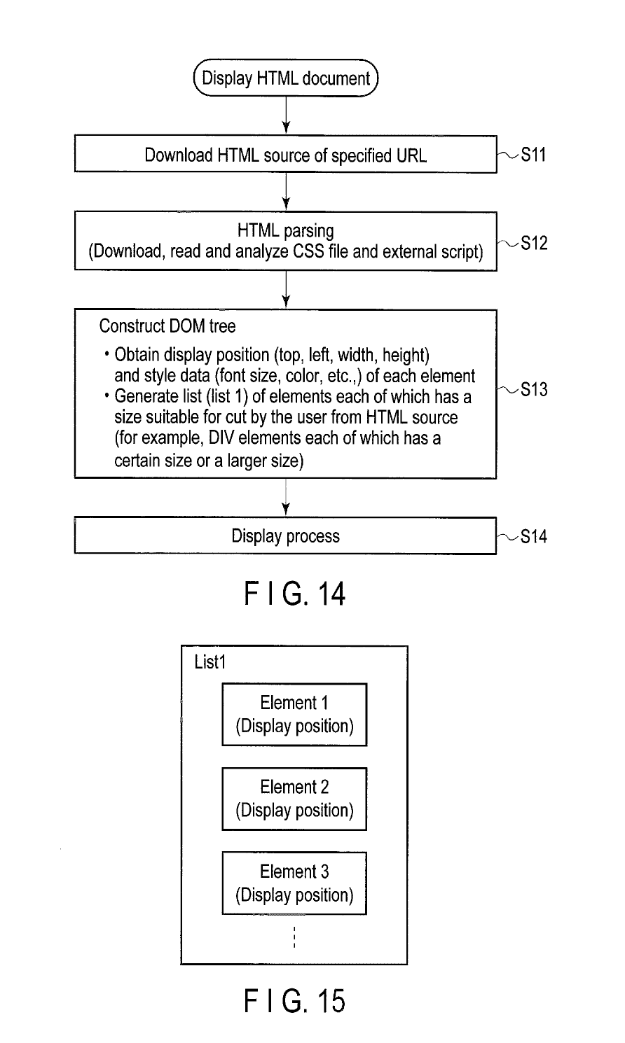

The flowchart of FIG. 14 shows a procedure of a process for displaying the content of an HTML document.

The CPU 101 performs the following process by executing the browser application program 202.

The CPU 101 downloads the HTML document (HTML source) of the specified URL (step S11). The CPU 101 starts parsing the HTML document (step S12). In step S12, the CPU 101 also downloads and analyzes an external CSS file and an external script.

The CPU 101 constructs a DOM tree based on the parsing result of the HTML document and the analysis result of the CSS file (step S13). In step S13, the CPU 101 determines the display position (top, left, width, height) of each element in the HTML document and the style (the font size, the color, etc.,) of each element. The determined display position and determined style of each element are retained in the corresponding object in the DOM tree. The CPU 101 may generate the list (list 1) shown in FIG. 15. List 1 is a list of elements each of which has a size suitable for cut by the user. In list 1, each element may retain its display position.

The CPU 101 displays on the screen the content of the HTML document, or in other words, the content item corresponding to each element in the HTML document on the basis of the DOM tree (step S14).

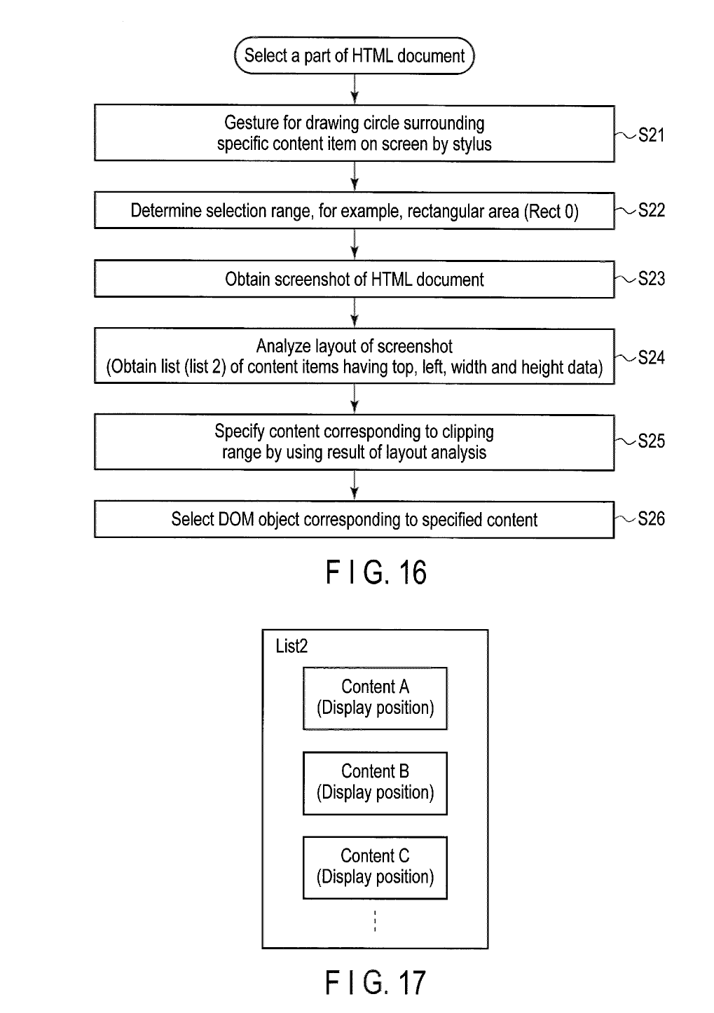

The flowchart of FIG. 16 shows a procedure of a process for selecting an element which corresponds to the clipping range and should be clipped.

The CPU 101 detects a gesture which draws a circular stroke surrounding a specific content item on the screen (step S21). The CPU 101 determines that an area surrounding the stroke is the selection range (clipping range). For example, the CPU 101 determines that the circumscribed rectangle (Rect 0) of the stroke is the selection range (clipping range) (step S22). The CPU 101 obtains the screenshot of the HTML document which is displayed on the screen as the document image of the Web page which is displayed in progress (step S23).

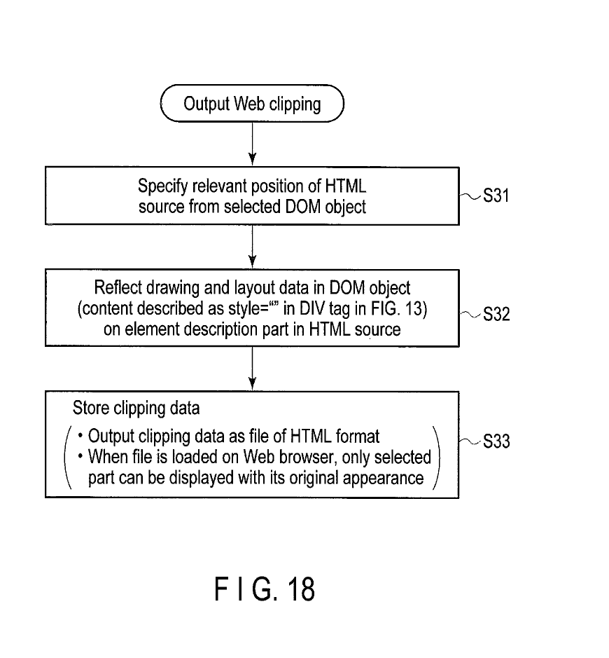

The CPU 101 starts the layout analysis of the screenshot of the HTML document (step S24). In step S24, the display position (top, left, width, height) of each block (content item) in the screenshot is calculated for each block (content item) having a size suitable for cut by the user (step S24). As shown in FIG. 17, a list (list 2) of content items in the screenshot may be generated. In list 2, each content item may retain its display position.

The CPU 101 specifies the content item corresponding to the clipping range (Rect 0) by comparing the position of the clipping range (Rect 0) with the display position (top, left, width, height) of each content item (step S25). In step 25, the CPU 101 may compare the position of Rect 0 with the display position of each content item in list 2. The content item which overlaps Rect 0 is specified as the content item corresponding to Rect 0. The CPU 101 may specify only the content item having an area which overlaps Rect 0 and is greater than a standard area as the content item corresponding to Rect 0. In this manner, it is possible to prevent the problem that an unintended content item is specified as the content item corresponding to Rect 0.

The CPU 101 selects the element corresponding to the specified content item (the DOM object corresponding to the specified content item (step S26). In step S26, the CPU 101 may specify the element corresponding to the specified content item (the DOM object corresponding to the specified content item) by comparing list 2 with list 1. In this case, an element which is in list 1 and has the display position (top, left, width, height) similar to the display position (top, left, width, height) of the specified content item may be selected as the DOM object corresponding to the specified content item.

The CPU 101 may search the DOM tree for an element including recognized text in the specified content item in order to specify the DOM object corresponding to the specified content item.

The flowchart of FIG. 18 shows a procedure of a process for outputting clipping data (a Web clipping).

The CPU 101 specifies the element which is in the HTML document and which corresponds to the specified content item based on the selected DOM object (step S31). In step S31, the position corresponding to the selected DOM object is specified in the HTML document (HTML source). The element described in the position is specified as the element which is in the HTML document and which corresponds to the specified content item.

The CPU 101 takes out the element description part of the element corresponding to the specified content item from the HTML document, and reflects the style data (drawing and style data) of the selected DOM object on the element description part (step S32). More specifically, in step S32, the CPU 101 buries the element description part in the body element of a new HTML file. The CPU 101 further buries the style data (drawing and style data) of the selected DOM object in the buried element description part as a style attribute (style=“ ”).

The CPU 101 stores the new HTML file as clipping data (step S33). In step S33, the HTML file stored as clipping data already includes style data corresponding to the specified element. When the browser application program 202 loads the new HTML file, the content item corresponding to the element can be displayed in the same style as the original style.

FIG. 17 and FIG. 18 are explained based on the case where a DOM object is selected from the specified content item and an element in the HTML document is specified from the selected DOM object. However, an element in the HTML document may be directly specified from the specified content item. In this case, the CPU 101 may search the HTML document for an element including recognized text in the specified content item.

As explained above, in the present embodiment, the content of the HTML document including a plurality of elements is displayed on the screen. A process for storing a part of the HTML document as clipping data is performed in accordance with the clipping range on the screen which is specified by a handwritten stroke (clipping stroke). The part of the HTML document includes one or more first elements of the plurality of elements. The first element(s) (the element(s) to be extracted) is (are) determined by comparing the clipping range with display positions on the screen on which contents of elements are displayed respectively. The display positions are obtained from the screen image (e.g., screen shot) of the HTML document which is displayed on the screen. Thus, the element(s) to be extracted is (are) determined by using a screen image having a layout which is very similar to the layout of the Web page the user is actually viewing. In this manner, it is possible to accurately specify the element(s) corresponding to the part intended by the user.

Thus, the user can easily prepare clipping data including the element corresponding to the part intended by the user by merely writing a stroke by hand in the interesting part on the Web page.

Each of various functions described in the present embodiment may be realized by circuitry (processing circuitry). For example, the processing circuitry may be a programmed processor such as a central processing unit (CPU). The processor executes each of the described functions by executing a computer program (command group) stored in a memory. The processor may be a microprocessor including an electric circuit. For example, the processing circuitry may be a digital signal processor (DSP), an application specific integrated circuit (ASIC), a microcontroller, a controller or other electric circuit components. Each of the components described in the present embodiment other than the CPU may be realized by processing circuitry.

Various processes in the present embodiment can be realized by a computer program. Therefore, it is possible to easily realize an effect which is similar to that of the present embodiment by merely installing the computer program into a computer through a computer-readable storage medium in which the computer program is stored, and executing the program.

The present embodiment is explained based on the example in which a tablet computer is employed. However, each function of the present embodiment can be applied to a normal desktop personal computer. In this case, for example, a tablet which is an input device for handwriting input may be connected to a desktop personal computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display controller configured to display content of a first document described in a markup language on a screen, the first document comprising a plurality of elements; and
circuitry configured to perform a process of storing a part of the first document as clipping data based on a first clipping range on the screen, the first clipping range specified by a first handwritten stroke, the part of the first document comprising one or more first elements of the plurality of elements, wherein:
the one or more first elements are determined by comparing the first clipping range with display positions on the screen on which contents of elements are displayed respectively, and
the display positions are obtained from a screen image of the first document displayed on the screen.

2. The electronic device of claim 1, wherein the clipping data comprises a second document described in a markup language, the second document comprising the one or more first elements.

3. The electronic device of claim 2, wherein
the contents of the plurality of elements are displayed based on first style data for drawing the plurality of elements, and
the second document comprises second style data for drawing the one or more first elements, and the second style data is obtained from the first style data.

4. The electronic device of claim 1, wherein the screen image comprises a screenshot of the first document displayed on the screen.

5. The electronic device of claim 1, wherein
the circuitry is further configured to perform a process of drawing a second handwritten stroke on the content of the first document, when the circuitry receives the second handwritten stroke in a handwriting mode, and
the circuitry is further configured to perform a process of storing the first document on which the second handwritten stroke is drawn as image data, and storing text in the first document in association with the image data, when the circuitry detects a request for storing the first document as image data.

6. A method comprising:
displaying content of a first document described in a markup language on a screen, the first document comprising a plurality of elements; and
storing a part of the first document as clipping data, based on a first clipping range on the screen, the first clipping range specified by a first handwritten stroke, the part of the first document comprising one or more first elements of the plurality of elements, wherein:
the one or more first elements are determined by comparing the first clipping range with display positions on the screen on which contents of elements are displayed respectively, and
the display positions are obtained from a screen image of the first document displayed on the screen.

7. The method of claim 6, wherein the clipping data comprises a second document described in a markup language, the second document comprising the one or more first elements.

8. The method of claim 7, wherein
the contents of the plurality of elements are displayed based on first style data for drawing the plurality of elements, and
the second document comprises second style data for drawing the one or more first elements, and the second style data is obtained from the first style data.

9. The method of claim 6, wherein the screen image comprises a screenshot of the first document displayed on the screen.

10. The method of claim 6, further comprising:
drawing a second handwritten stroke on the content of the first document, when receiving the second handwritten stroke in a handwriting mode; and
storing the first document on which the second handwritten stroke is drawn as image data, and storing text in the first document in association with the image data, when detecting a request for storing the first document as image data.

11. A computer-readable, non-transitory storage medium having stored thereon a computer program which is executable by a computer, the computer program controlling the computer to execute functions of:
displaying content of a first document described in a markup language on a screen, the first document comprising a plurality of elements; and
storing a part of the first document as clipping data, based on a first clipping range on the screen, the first clipping range specified by a first handwritten stroke, the part of the first document comprising one or more first elements of the plurality of elements, wherein:
the one or more first elements are determined by comparing the first clipping range with display positions on the screen on which contents of elements are displayed respectively, and
the display positions are obtained from a screen image of the first document displayed on the screen.

12. The medium of claim 11, wherein the clipping data comprises a second document described in a markup language, the second document comprising the one or more first elements.

13. The medium of claim 12, wherein
the contents of the plurality of elements are displayed based on first style data for drawing the plurality of elements, and
the second document comprises second style data for drawing the one or more first elements, and the second style data is obtained from the first style data.

14. The medium of claim 11, wherein the screen image comprises a screenshot of the first document displayed on the screen.

15. The medium of claim 11, wherein the computer program further controls the computer to execute functions of:
drawing a second handwritten stroke on the content of the first document, when receiving the second handwritten stroke in a handwriting mode; and
storing the first document on which the second handwritten stroke is drawn as image data, and storing text in the first document in association with the image data, when detecting a request for storing the first document as image data.
